(19) United States
(12) Patent Application Publication
(10) Pub. No.: US 2011/0289402 A1
(43) Pub. Date: Nov. 24, 2011

(54) Methods and Apparatuses for Generating and Utilizing Haptic Style Sheets

(75) Inventors: Kari Juhani Hiitola, Tampere (FI); Kim Mikael Gronholm, Kotka (FI)

(73) Assignee: NOKIA CORPORATION, Espoo (FI)

(21) Appl. No.: 12/951,042

(22) Filed: Nov. 20, 2010

Related U.S. Application Data
(60) Provisional application No. 61/263,084, filed on Nov. 20, 2009.

(51) Int. Cl. G06F 17/21

(52) U.S. Cl. 715/234

(57) ABSTRACT

Various methods for generating and utilizing haptic style sheets are provided. One example method according to an example embodiment of the present invention includes retrieving content and a style sheet associated with a web page and receiving a type of user input with respect to an element of the web page. The example method may further include accessing the style sheet to determine a haptic feedback style for the element based on the type of user input and directing the apparatus to implement the haptic feedback feature associated with the haptic feedback style. Related example methods and example apparatuses are also provided.

### CROSS-REFERENCE TO RELATED APPLICATIONS

The present application claims priority to U.S. Provisional Application No. 61/263,084 filed Nov. 20, 2009 entitled “Methods and Apparatuses for Generating and Utilizing Haptic Style Sheets,” the contents of which are incorporated by reference herein in their entirety.

### TECHNICAL FIELD

Embodiments of the present invention relate generally to user interface technology, and, more particularly, relate to methods and apparatuses for generating and using haptic style sheets.

### BACKGROUND

Haptic technology is becoming more prevalent at least partially due to the evolution of touch screen devices. Haptic feedback is the use of forces, vibrations, possibly with sounds, to provide a user with the sensation of “feeling” changes on a touch screen or the like. Different types of vibrations (e.g., slow or fast vibrations) may be used to simulate touching physical objects, such as buttons, different kinds of surfaces, and physical boundaries. In this regard, haptic feedback provides a mechanism for addressing the inability of a user to, for example, feel the keys of a keypad on a touch screen display.

When implementing haptic feedback, latency can be problematic. Delay in the feedback response to touch events on a touch screen display can often be readily apparent to a user. As such, if a device is slow in providing haptic feedback to the user, the user experience can be substantially diminished.

### BRIEF SUMMARY

Various example methods and apparatuses of the present invention are described herein for generating and utilizing haptic style sheets. According to some example embodiments, web content elements may be defined with haptic feedback styles within a web page style sheet. By defining the haptic feedback styles within a style sheet, latency may be minimized. Elements within a style sheet may be defined to exhibit particular haptic feedback features defined by the haptic feedback style in response to, for example, a touch, a move, a touch release, or the like (collectively referred to as touch events) performed by a user. According to some example embodiments, haptic feedback styles may be predefined with respect to particular elements included within a style sheet.

According to some example embodiments, a web browser implemented by a communications device that supports haptic feedback may be configured to navigate to a web page. The browser may be configured to retrieve content associated with the web page and a style sheet associated with the web page. According to various example embodiments, the style sheet may be defined to include haptic feedback styles associated with elements of the style sheet. Via the browser, the commutations device may be configured to provide haptic feedback features based on the haptic feedback styles, in response to user interaction with a web page element (e.g., a touch event) by accessing the style sheet and implementing the haptic feedback feature.

One example method according to an example embodiment of the present invention includes retrieving content and a style sheet associated with a web page and receiving a type of user input with respect to an element of the web page. The example method may further include accessing the style sheet to determine a haptic feedback style for the element based on the type of user input and directing the apparatus to implement the haptic feedback feature associated with the haptic feedback style.

A related example apparatus comprises at least one processor and at least one memory including computer program code, the at least one memory and the computer program code configured to, with the at least one processor, cause the apparatus at least to perform various functionalities. In this regard, the example apparatus is caused to perform retrieving content and a style sheet associated with a web page and receiving a type of user input with respect to an element of the web page. The example method may further include accessing the style sheet to determine a haptic feedback style for the element based on the type of user input and directing the apparatus to implement the haptic feedback feature associated with the haptic feedback style.

Another example embodiment is an example computer-readable storage medium having executable computer-readable program code instructions stored therein. The computer-readable program code instructions of the example computer-readable storage medium are for causing an apparatus to perform various functionalities. In this regard, the example apparatus is caused to perform retrieving content and a style sheet associated with a web page and receiving a type of user input with respect to an element of the web page. The example method may further include accessing the style sheet to determine a haptic feedback style for the element based on the type of user input and directing the apparatus to implement the haptic feedback feature associated with the haptic feedback style.

Another example embodiment is an example apparatus. The example apparatus comprises means for retrieving content and a style sheet associated with a web page and means for receiving a type of user input with respect to an element of the web page. The example method may further include means for accessing the style sheet to determine a haptic feedback style for the element based on the type of user input and means for directing the apparatus to implement the haptic feedback feature associated with the haptic feedback style.

### BRIEF DESCRIPTION OF THE DRAWING(S)

Having thus described the invention in general terms, reference will now be made to the accompanying drawings, which are not necessarily drawn to scale, and wherein:

FIG. 1 illustrates an example implementation architecture using haptic style sheets according to an example embodiment of the present invention;

FIG. 2 illustrates example code for referencing haptic style sheets according to an example embodiment of the present invention;

FIG. 3 illustrates operations associated with a touch procedure according to an example embodiment of the present invention;

FIG. 4 illustrates a block diagram of an apparatus for generating and utilizing haptic style sheets according to an example embodiment of the present invention;

FIG. 5 illustrates a block diagram of a mobile terminal according to an example embodiment of the present invention; and

FIG. 6 illustrates a flow chart of a method for utilizing haptic style sheets according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Some example embodiments of the present invention define haptic feedback styles within a style sheet, such as a web style sheet. Based on the defined style, a device may be configured to implement a haptic feedback feature (e.g., vibrate the device in a particular manner). Web style sheets may be, for example files or data structures separate from a web page's content and structure as defined by the markup (e.g., hypertext markup language (HTML) or extensible HTML (XHTML)) for defining the visual layout of a web page. Style sheets may be defined using a style sheet language, such as cascading style sheets (CSS) or extensible style sheet language (XSL). Style sheets may define various properties of elements within a web page, such as position, size, colors, background, and fonts. An element of a web page may be a button, a text box, a web link, text entry field, a scroll bar, a control, or the like.

According to some example embodiments, style sheets may include definitions for haptic feedback styles associated with elements that are defined in the style sheet. The use of style sheets for facilitating the implementation of haptic feedback with respect to web page content, according to some example embodiments, allows for utilization of dynamic programming languages, such as JavaScript, for application development. In this regard, web widgets, web applications, and the like may be developed with haptic feedback styles for use with a web browser. Additionally, implementation of haptic feedback features using the haptic feedback styles defined in the style sheets, according to some example embodiments, also provides for relatively reduced latency and an improved user experience.

Accordingly, style sheets may be extended for defining haptic feedback styles for any element in a web page or within web content as a part of the style. Each element of a page may be assigned styles that define the type of haptic feedback feature that is implemented when, for example, a touch, move, or touch release occurs. According to some example embodiments, a number of haptic feedback style parameters may be defined with respect to a given element. In this regard, a haptic tap style, a haptic drag style, a haptic texture style, a haptic shape style, and the like may be defined for each element of a style sheet. A tap event style may define what the element should feel like when pushed. A haptic drag style may define what the element should feel like when dragged. A haptic texture style may define what an element should feel like when sliding a finger on the element, when scrolling or dragging is not occurring. A haptic shape style may defined what the element boundary should feel like when sliding the finger onto or off from the element. Further, the haptic feedback style for each element may be modified by the web application by changing the style with an existing JavaScript style API. For example, inactive buttons may be dynamically given a “stuck button” haptic tap style so that a user can feel pushing them doesn't have an effect.

To implement haptic feedback features, a device with a touch screen display may include, for example, a vibra motor (also referred to as a vibra), which may be an eccentric mass with a motor. In some example embodiments, a piezo actuator (also referred to as a piezo) may additionally or alternatively be included for physically moving the touch screen display of the device. Additionally, or alternatively, audio functionality may also be implemented to add to the haptic feedback to the user.

According to some example embodiments, haptic feedback style parameters for a given element within a style sheet may be set to a default value. Further, a default style sheet may be defined for HTML elements. Additionally or alternatively, a developer may override the defaults associated with a particular element to generate a unique combination.

According to some example embodiments, haptic feedback styles may be implemented via a “reactive” application programming interface (API) or an “area registry” API. A reactive API may be implemented where the application layer receives touch events on a touch screen device, and, based on the conditions, a decision may be made as to whether haptic feedback is applicable. The application layer may then call the reactive API with an appropriate feedback as a parameter.

An area registry API may be implemented where a system layer maintains a registry of screen areas that are associated with different haptic feedback styles when interacted with by a user (e.g., via a touch, a move or swipe, or a touch release). In this regard, the application layer may send updates to the system layer when the elements, or the feedback associated with the elements, change. In this regard, the system layer may receive and process touch events without sending information about the touch events to the application layer.

The haptic style sheet extensions may be implemented on top of either a “reactive” or an “area registry” style API. According to various example embodiments, latency requirement may be satisfied with either approach.

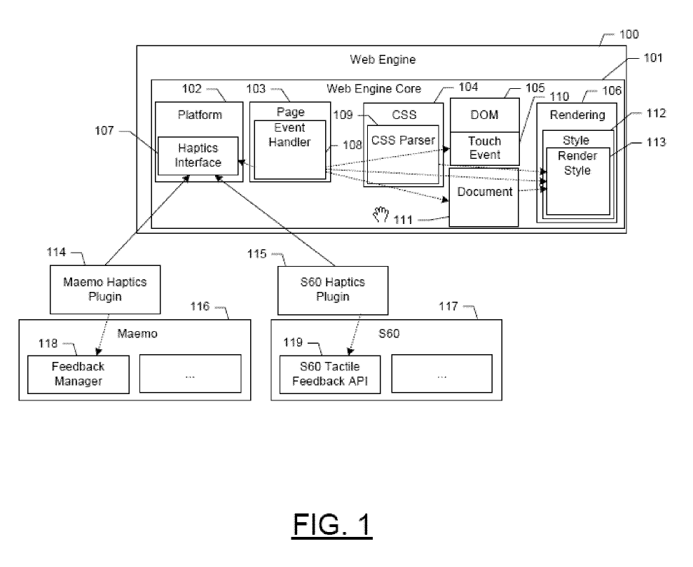

FIG. 1 illustrates and example architecture within a web engine implementation. The web engine core 101 of the web engine 100 may include a platform 102, the page 103, CSS 104, document object model (DOM) 105, and a rendering module 106. The platform 102 may include a haptics interface 107, which may be connected to haptic plugins for a platform or operating system type. As depicted in FIG. 1, the haptics interface 107 resides above a Maemo haptics plugin 114 and an S60 haptics plugin 115. The Maemo haptics plugin 114 may interface with the Maemo platform 116 and the included feedback manager 118. The S60 haptics plugin 115 may interface with the S60 platform 117 and the included S60 Tactile Feedback API 119.

The page 103 may include an event handler 108 that is connected to the haptics interface 107, the touch event handler 110 of the DOM 105, and the document 111. The CSS parser 109 of the CSS 104 may also be connected to the render style 113 of the style 112 and the rendering module 106. The event handler 110, which may be implemented by a processor, may check to determine which haptic style parameters are defined for the touched element, and call the haptics interface 107. As mentioned above, the haptic interface 107 may be implemented by platform specific plugins, which may be configured to map the feedbacks to concrete platform-specific feedbacks.

According to some example embodiments, each haptic style within the style sheet may be associated with an element as a metaphor for the haptic style with respect to the element. Example metaphors implemented for the tap style may be a button, latched up/down/stuck button, a link, a text box, or a checked or unchecked checkbox. The haptic tap style may then be transparently mapped to proper haptic feedbacks to be implemented on touch and touch release, or when movement causes the tap action to be cancelled. Further, a strength parameter for each of the haptic feedback features can be defined in the haptic feedback style.

According to some example embodiments, metaphors implemented for the drag style may be a uniform surface, bumpy, buzzer, drag and drop, drag without drop, grid, flick, horizontal, or vertical lists. The haptic drag style may then be transparently mapped to proper haptic feedbacks to be implemented on touch, move, and touch release. According to some example embodiments, an additional parameter defining the distance of bumps may be defined applicable specifically to list and grid drag styles.

According to some example embodiments, the haptic shape may be convex, concave, soft-convex, soft-concave, sharp-convex, and sharp-concave. Convex styles may feel like the surface is higher than the surroundings, and concave styles may feel like the surface is lower than the surroundings.

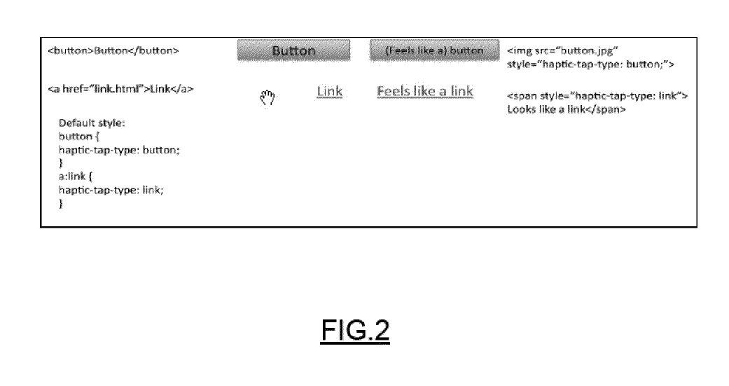

FIG. 2 depicts a haptic behavior implemented with a browser vendor's default style sheet for interactive HTML elements, and elements crafted from image and text elements. Based on the content of FIG. 2, the markup for a haptic button and link are provided. In this regard, through the use of a default style sheet, web site designers may simply utilize the predefined interactive elements. Alternative to the use of the defaults, a designer may create custom interactive elements and associated haptic feedback styles.

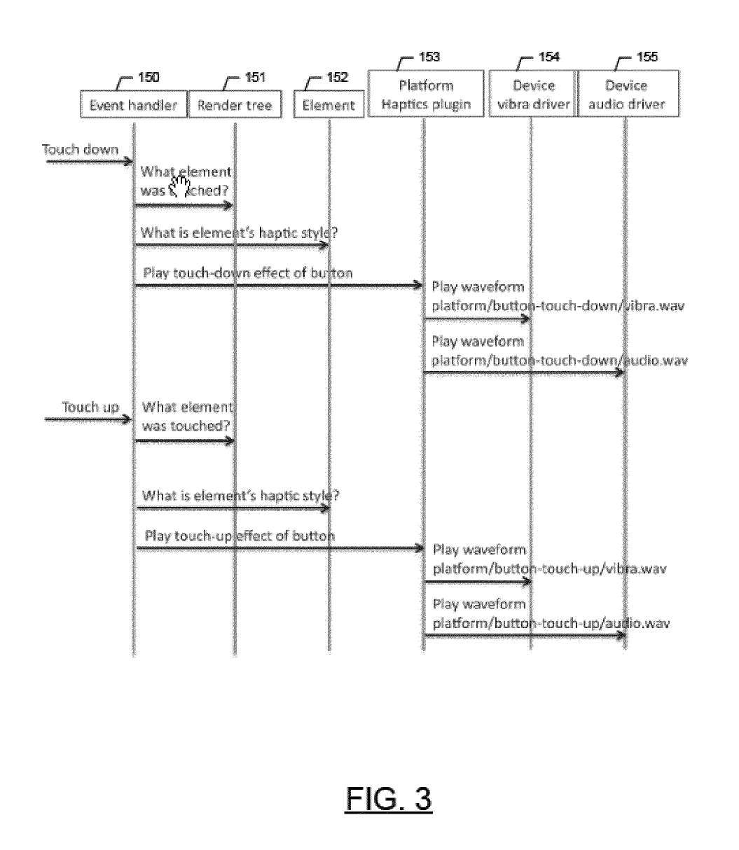

FIG. 3 depicts an example button click as a simplified flow of how related touch events and the touched element's haptic style may be translated into concrete waveforms to be played on a vibra and/or an audio device simultaneously. When a touch down event is received by the event handler 150, a render tree 151 may be checked to identify the elements that are in the touch event's coordinates (a button). The identified element 152's tap haptic style may then be queried, for example from the style sheet, and based on the result, the platform-specific haptics plugin 153 may be asked to play a touch down effect of haptic feedback style using haptics plugin 153. The haptics plugin 153 may then play the waveforms that are applicable to the device/platform via the device vibra driver 154 and the device audio driver 155. According to some example embodiments, some or all of the playback devices may be omitted to match the generic haptic style of the device. A similar process may be described with respect to the touch up or touch release as depicted in FIG. 3

Through the implementation of various example embodiments, benefits and advantages may be realized, such as reduced latency relative to other solutions. According to various example embodiments, the implementation of the haptic interface as described above is technology agnostic, such that a similar feel can be produced with a vibra, a piezo, an audio device, or a combination thereof. Additionally, in accordance with various example embodiments, haptic feedback styles are consistent within the device between both native applications and web pages, resulting in a consistent user experience. Further, the default haptic feedback styles may be defined and overridden with currently well-defined and well-understood rules. If some of the properties are not supported in all devices, according to some example embodiments, a web developer will not need to add complexity in error handling, since the failure of style sheet functionality degrades gracefully. Web developers also will not need to specify the specific waveforms to be implemented on each device type, according to various example embodiments, because the underlying system does the mapping from the metaphor to correct waveforms to be run on a vibra, piezo, and/or audio device. Additionally, according to various example embodiments, cascading style sheets have versatile selectors and inheritance, which allows very flexible rules for selecting a haptic feedback style.

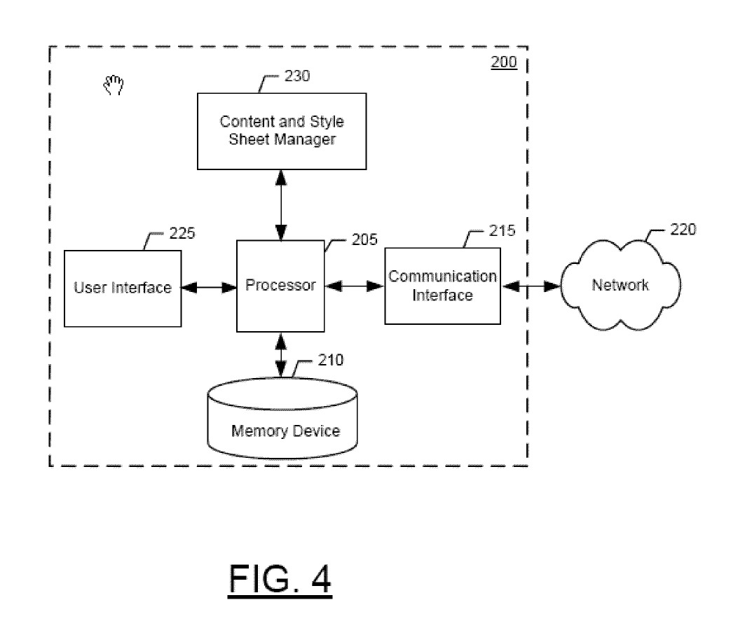

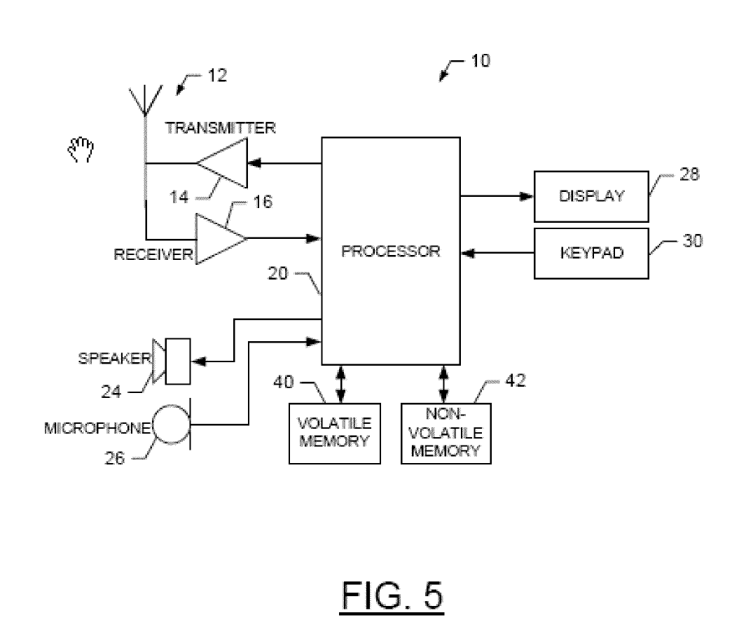

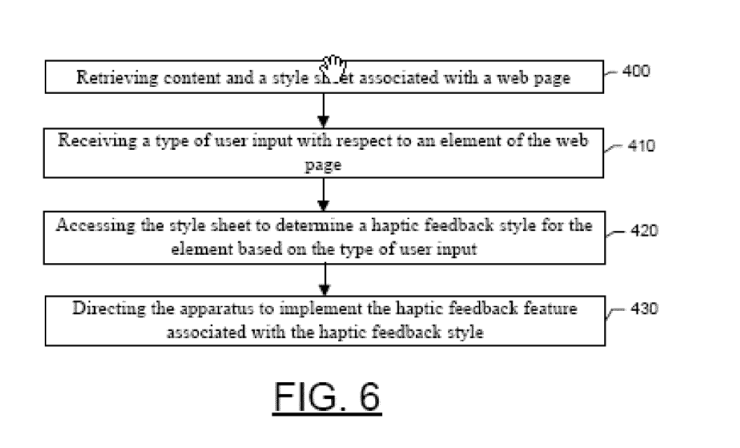

The description provided above and generally herein illustrates example methods and example apparatuses for generating and utilizing haptic style sheets. Based on the forgoing, FIGS. 4 and 5 illustrate example apparatus embodiments of the present invention configured to perform the various functionalities described herein. FIG. 6 depicts an example method for utilizing haptic feedback style sheets as described herein.

Referring now to FIG. 4, in some example embodiments, the apparatus 200 may be embodied as, or may be included as, a component of, a communications device with wired or wireless communications capabilities. In some example embodiments, the apparatus 200 may be part of a communications device such as a stationary or a mobile terminal. As a stationary terminal, the apparatus 200 may be part of a computer, server, an access point (e.g., a base station, wireless router, or the like), a device that supports network communications, or the like. As a mobile terminal, the apparatus 200 may be a mobile computer, mobile telephone, a portable digital assistant (PDA), a pager, a mobile television, a gaming device, a mobile computer, a laptop computer possibly with a wireless modem, a camera, a video recorder, an audio/video player, a radio, and/or a global positioning system (GPS) device, any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, user interface 220, and a source connection manager 230. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to example embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes random access memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 215 and the user interface 220. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 215 may be any device or means embodied in either hardware, a computer program product, or a combination of hardware and a computer program product that is configured to receive and/or transmit data from/to a network and/or any other device or module in communication with the example apparatus 200. In some example embodiments, the communications interface may be part of, or include, a wireless modem connected to a personal computer. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 220 may be in communication with the processor 205 to receive user input via the user interface 220 and/or to present output to a user as, for example, audible, visual, mechanical or other output indications. The user interface 220 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). The user interface 220 may also be configured to support the implementation of haptic feedback. In this regard, the user interface 220, as controlled by processor 205, may include a vibra, a piezo, and/or an audio device configured for haptic feedback as described herein. In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The content and style sheet manager 230 of example apparatus 200 may be any means or device embodied, partially or wholly, in hardware, a computer program product, or a combination of hardware and a computer program product, such as processor 205 implementing stored instructions to configure the example apparatus 200, memory device 210 storing executable program code instructions configured to carry out the functions described herein, or a hardware configured processor 205 that is configured to carry out the functions of the content and style sheet manager 230 as described herein. In an example embodiment, the processor 205 includes, or controls, the content and style sheet manager 230. The content and style sheet manager 230 may be, partially or wholly, embodied as processors similar to, but separate from processor 205. In this regard, the content and style sheet manager 230 may be in communication with the processor 205. In various example embodiments, the content and style sheet manager 230 may, partially or wholly, reside on differing apparatuses such that some or all of the functionality of the content and style sheet manager 230 may be performed by a first apparatus, and the remainder of the functionality of the content and style sheet manager 230 may be performed by one or more other apparatuses.

The apparatus 200 and the processor 205 may be configured to perform the following functionality via the content and style sheet manager 230. The content and style sheet manager 230 may be configured to perform a number of operations of an example method, such as the example method depicted in FIG. 6. In this regard, the content and style sheet manager may be configured to retrieve content and a style sheet associated with a web page, at 400, and receive a type of user input with respect to an element of the web page at 410. Retrieval of the content and style sheet may be performed via a web browser that is implemented by the processor 205, and an event handler associated with the page may receive the type of user input. Additionally, in accordance with various example embodiments, types of user input may include touch events such as touch, move, touch release, and the like. The content and style sheet manager 230 may also be configured to access the style sheet to determine a haptic feedback style for the element based on the type of user input at 420. In this regard, the style sheet may be a CSS or XSL style sheet. Further, the information regarding haptic feedback feature may be accessed via a haptics interface to a style sheet. The content and style sheet manager 230 may also be configured to direct the apparatus 200 to implement the haptic feedback feature associated with the haptic feedback style at 430. According to some example embodiments, directing implementation of the haptic feedback feature may include utilizing a mapping between a haptic interface and an operating platform or system layer, via a plugin, to determine the haptic feedback style and implement the haptic feedback feature. Implementation of the haptic feedback feature may be performed using a device driver for haptic feedback.

Referring now to FIG. 5, a more specific example apparatus in accordance with various embodiments of the present invention is provided. The example apparatus of FIG. 5 is a mobile terminal 10 configured to communicate within a wireless network, such as a cellular communications network. The mobile terminal 10 may be configured to perform the functionality of the apparatus 200 or other example apparatuses as described herein. More specifically, the mobile terminal 10 may be caused to perform the functionality of the content and style sheet manager 230 and/or the operations of FIG. 6 via the processor 20. In this regard, processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface. In some example embodiments, the mobile terminal 10 may also include a vibra, a piezo, an audio device, or the like configured to provide haptic feedback as described herein.

FIG. 6 illustrates flowcharts of example systems, methods, and/or computer program products according to example embodiments of the invention. It will be understood that each operation of the flowcharts, and/or combinations operations in the flowcharts, can be implemented by various means. Means for implementing the operations of the flowcharts, combinations operations in the flowcharts, or other functionality of example embodiments of the present invention described herein may include hardware, and/or a computer program product including a non-transitory computer-readable storage medium (as opposed to a computer-readable transmission medium which describes a propagating signal) having one or more computer program code instructions, program instructions, or executable computer-readable program code instructions stored therein. In this regard, program code instructions may be stored on a memory device, such as memory device 210, of an example apparatus, such as example apparatus 200, and executed by a processor, such as the processor 205. As will be appreciated, any such program code instructions may be loaded onto a computer or other programmable apparatus (e.g., processor 205, memory device 210, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the operations of the flowcharts in a computer-readable storage medium, support combinations of operations for performing the specified functions. It will also be understood that one or more operations of the flowcharts, and combinations of operations in the flowcharts, may be implemented by special purpose hardware-based computer systems and/or processors which perform the specified functions, or combinations of special purpose hardware and program code instructions.

The following provides additional example embodiments of the present invention. One example method according to an example embodiment of the present invention includes retrieving content and a style sheet associated with a web page and receiving a type of user input with respect to an element of the web page. The example method may further include accessing the style sheet to determine a haptic feedback style for the element based on the type of user input and directing the apparatus to implement the haptic feedback feature associated with the haptic feedback style. According to some example embodiments, the retrieval of the content and style sheet may be performed via a web browser that is implemented by a processor, and an event handler associated with the page may receive the type of user input. According to some example embodiments, the style sheet may be a CSS or XSL style sheet. According to some example embodiments, information regarding haptic feedback style may be accessed via a haptics interface to a style sheet. According to some example embodiments, directing implementation of the haptic feedback feature may include utilizing a mapping between a haptic interface and an operating platform or system layer, via a plugin, to determine the haptic feedback style and implement the haptic feedback feature. Implementation of the haptic feedback feature may be performed using a device driver for haptic feedback.

A related example apparatus comprises at least one processor and at least one memory including computer program code, the at least one memory and the computer program code configured to, with the at least one processor, cause the apparatus at least to perform various functionalities. In this regard, the example apparatus is caused to perform retrieving content and a style sheet associated with a web page and receiving a type of user input with respect to an element of the web page. The example method may further include accessing the style sheet to determine a haptic feedback feature for the element based on the type of user input and directing the apparatus to implement the haptic feedback feature. According to some example embodiments, the retrieval of the content and style sheet may be performed via a web browser that is implemented by a processor, and an event handler associated with the page may receive the type of user input. According to some example embodiments, the style sheet may be a CSS or XSL style sheet. According to some example embodiments, information regarding haptic feedback style may be accessed via a haptics interface to a style sheet. According to some example embodiments, directing implementation of the haptic feedback feature may include utilizing a mapping between a haptic interface and an operating platform or system layer, via a plugin, to determine the haptic feedback style and implement the haptic feedback feature. Implementation of the haptic feedback feature may be performed using a device driver for haptic feedback.

Another example embodiment is an example computer-readable storage medium having executable computer-readable program code instructions stored therein. The computer-readable program code instructions of the example computer-readable storage medium are for causing an apparatus to perform various functionalities. In this regard, the example apparatus is caused to perform retrieving content and a style sheet associated with a web page and receiving a type of user input with respect to an element of the web page. The example method may further include accessing the style sheet to determine a haptic feedback feature for the element based on the type of user input and directing the apparatus to implement the haptic feedback feature. According to some example embodiments, the retrieval of the content and style sheet may be performed via a web browser that is implemented by a processor, and an event handler associated with the page may receive the type of user input. According to some example embodiments, the style sheet may be a CSS or XSL style sheet. According to some example embodiments, information regarding haptic feedback style may be accessed via a haptics interface to a style sheet. According to some example embodiments, directing implementation of the haptic feedback feature may include utilizing a mapping between a haptic interface and an operating platform or system layer, via a plugin, to determine the haptic feedback style and implement the haptic feedback feature. Implementation of the haptic feedback feature may be performed using a device driver for haptic feedback.

Another example embodiment is an example apparatus. The example apparatus comprises means for retrieving content and a style sheet associated with a web page and means for receiving a type of user input with respect to an element of the web page. The example method may further include means for accessing the style sheet to determine a haptic feedback feature for the element based on the type of user input and directing the apparatus to implement the haptic feedback feature. According to some example embodiments, the retrieval of the content and style sheet may be performed via a web browser that is implemented by a processor, and an event handler associated with the page may receive the type of user input. According to some example embodiments, the style sheet may be a CSS or XSL style sheet. According to some example embodiments, information regarding haptic feedback style may be accessed via a haptics interface to a style sheet. According to some example embodiments, directing implementation of the haptic feedback feature may include utilizing a mapping between a haptic interface and an operating platform or system layer, via a plugin, to determine the haptic feedback style and implement the haptic feedback feature. Implementation of the haptic feedback feature may be performed using a device driver for haptic feedback.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
causing content and a style sheet associated with a web page to be retrieved;
receiving a type of user input with respect to an element of the web page;
accessing, via a processor, the style sheet to determine a haptic feedback style for the element based on the type of user input; and
causing implementation of a haptic feedback feature associated with the determined haptic feedback style.

2. The method of claim 1, wherein causing the content and style sheet to be retrieved includes causing the content and style sheet to be retrieved via a web browser, and
wherein receiving the type of user input includes receiving the type of user input via an event handler associated with the web page.

3. The method of claim 1, wherein causing the style sheet to be retrieved includes causing a cascading style sheet or an extensible stylesheet language style sheet to be retrieved.

4. The method of claim 1, wherein accessing the style sheet to determine a haptic feedback style includes accessing the style sheet via a haptic interface to the style sheet to determine the haptic feedback style.

5. The method of claim 1, wherein accessing the style sheet includes utilizing a mapping between a haptic interface and an operating platform or system layer to access the style sheet and determine the haptic feedback style.

6. The method of claim 1, wherein accessing the style sheet includes utilizing a mapping between a haptic interface and an operating platform or system layer, via a plugin, to access the style sheet and determine the haptic feedback style.

7. The method of claim 1, wherein causing implementation of the haptic feedback feature includes causing implementation of the haptic feedback feature via a device driver for haptic feedback.

8. An apparatus comprising at least one processor and at least one memory including computer program code, the at least one memory and the computer program code configured to, with the at least one processor, direct the apparatus at least to:
cause content and a style sheet associated with a web page to be retrieved;
receive a type of user input with respect to an element of the web page;
access the style sheet to determine a haptic feedback style for the element based on the type of user input; and
cause implementation of a haptic feedback feature associated with the determined haptic feedback style.

9. The apparatus of claim 8, wherein the apparatus directed to cause the content and style sheet to be retrieved includes being directed to cause the content and style sheet to be retrieved via a web browser, and
wherein the apparatus directed to receive the type of user input includes being directed to receive the type of user input via an event handler associated with the web page.

10. The apparatus of claim 8, wherein the apparatus directed to cause the style sheet to be retrieved includes being directed to cause a cascading style sheet or an extensible stylesheet language style sheet to be retrieved.

11. The apparatus of claim 8, wherein the apparatus directed to access the style sheet to determine a haptic feedback style includes being directed to access the style sheet via a haptic interface to the style sheet to determine the haptic feedback style.

12. The apparatus of claim 8, wherein the apparatus directed to access the style sheet includes being directed to utilize a mapping between a haptic interface and an operating platform or system layer to access the style sheet and determine the haptic feedback style.

13. The apparatus of claim 8, wherein the apparatus directed to access the style sheet includes being directed to utilize a mapping between a haptic interface and an operating platform or system layer, via a plugin, to access the style sheet and determine the haptic feedback style.

14. The apparatus of claim 8, wherein the apparatus directed to cause implementation of the haptic feedback feature includes being directed to cause implementation of the haptic feedback feature via a device driver for haptic feedback.

15. A computer program product comprising a non-transitory computer readable storage medium having computer program code stored therein, the computer program code being configured to direct an apparatus at least to:
cause content and a style sheet associated with a web page to be retrieved;
receive a type of user input with respect to an element of the web page;
access the style sheet to determine a haptic feedback style for the element based on the type of user input; and
cause implementation of a haptic feedback feature associated with the determined haptic feedback style.

16. The computer program product of claim 15, wherein the computer program code configured to direct the apparatus to cause the content and style sheet to be retrieved includes being configured to direct the apparatus to cause the content and style sheet to be retrieved via a web browser, and
wherein the computer program code configured to direct the apparatus to receive the type of user input includes being configured to direct the apparatus to receive the type of user input via an event handler associated with the web page.

17. The computer program product of claim 15, wherein the computer program code configured to direct the apparatus to cause the style sheet to be retrieved includes being configured to direct the apparatus to cause a cascading style sheet or an extensible stylesheet language style sheet to be retrieved.

18. The computer program product of claim 15, wherein the computer program code configured to direct the apparatus to access the style sheet to determine a haptic feedback style includes being configured to direct the apparatus to access the style sheet via a haptic interface to the style sheet to determine the haptic feedback style.

19. The computer program product of claim 15, wherein the computer program code configured to direct the apparatus to access the style sheet includes being configured to direct the apparatus to utilize a mapping between a haptic interface and an operating platform or system layer to access the style sheet and determine the haptic feedback style.

20. The computer program product of claim 15, wherein the computer program code configured to direct the apparatus to access the style sheet includes being configured to direct the apparatus to utilize a mapping between a haptic interface and an operating platform or system layer, via a plugin, to access the style sheet and determine the haptic feedback style.
